(19) United States
(12) Patent Application Publication
(10) Pub. No.: US 2001/0032153 A1
(43) Pub. Date: Oct. 18, 2001

(54) Method for the automation of allocation processes for products and/or services

(76) Inventor: Norbert Miller, Monchengladbach (DE)

Correspondence Address: Michael A. Cantor, Esq., CANTOR COLBURN LLP, 55 Griffin Road South, Bloomfield, CT, 06002, US

(21) Appl. No.: 09/769,827

(22) Filed: Jan. 24, 2001

(30) Foreign Application Priority Data
Jan. 24, 2000 (EP) 00101351.5

(51) Int. Cl. G06F 17/60

(52) U.S. Cl. 705/28

(57) ABSTRACT

A method for the automation of availability-checking, reservation and allocation/assignment processes for localized products and/or services, under utilization of a supraregional communications link and on the basis of a user's requirements, including: a) the user selecting a provider's product or service; b) the provider assigning to a requested item an authorization code which is transmitted to the user and is stored in a memory module of the user; c) the provider reserving the item, storing the code, and forwarding a reservation and code information to a code verification system, under utilization of a local-area communications link; d) triggering a non-contact, proximity code verification when the user enters within a range of the code verification system; and e) granting an access to the user upon a positive code verification.

This invention relates to a method for the automation of availability-checking, reservation and correlative identification and allocation processes for localized products and/or services.

In the service sector, extensive automation efforts have already been made and implemented. It is especially for the type of services that is adaptable to any given user group that the allocation of use privileges is to be made as simple and automated as conceivably possible. For example, there already exist semiautomatic use-authorization systems for issuing airline and railroad tickets, parking-garage and recreational-facility permits and the like. But in the realm of product dispensing as well, simplification efforts are afoot, following the example for instance of those so-called drive-ins and similar systems.

In the final analysis, however, prior-art systems are still unable to do without the exchange or transfer of documents such as printed authorization certificates and similar permits. This is due primarily to the fact that a uniquely individualized user identification is not possible. With semiautomatic systems, for instance those used in the issuance of airline tickets, reference is made to a special, provider-issued charge card or, most commonly, to a credit-card number, whereby the presentation of the special charge or credit card, or its insertion in a machine, results in the print-out of a ticket. All of these earlier, specialized system are for the most part mutually incompatible and uneconomical since they require numerous special devices, each customized for one particular purpose. Moreover, the user has to keep handy numerous documents, cards and the like and for every use he always ends up having to manually perform individual steps, for instance collecting or pulling out a parking-garage ticket, or printing out a travel ticket etc. Besides, most of the prior-art systems are not capable of also performing in fully automatic fashion such immediate follow-up steps as the automated generation of accounting statements.

It is therefore the objective of this invention to introduce a method in this general category which is easily adaptable to a large variety of applications, is automatically implementable and which, most of all, is as simplified for the user as is conceivably possible.

The invention also specifies systems for applying the method here disclosed.

For the technical solution, this invention proposes a method for the automation of availability-checking, reservation and correlative allocation processes for localized products and/or services, with the aid of a supraregional communications link and based on a user's requirement,

According to the method,

a) the user selects a provider's product item,

b) the provider assigns an authorization code to the product item, transmits the code to the user, and stores it in a memory module of the user,

c) the provider reserves the product, stores the code, and feeds a reservation and code data to a code verification system, under utilization of a local communications link,

d) a non-contact proximity code verification takes place when the user enters within a range of the code verification system, and

e) upon a positive code verification, the user is granted access or product release.

In the context of this invention, the term supraregional communications link refers to any existing or potential communication system that is preferably suitable for digital data transmission over great distances. At this juncture, this would include for instance wireless mobile phone networks. In particular, the supraregional communication between the user and the provider will involve the use of mobile communications transmitters, for instance cell phones, palmtops and the like. At least for the user, the utilization of a mobile communications transmitter is an important aspect in the simplification of the system's deployment since it is possible for the user to access localized products and/or services virtually from anywhere in the area.

The term localized products and/or services, in the context of this invention, refers to products which can be received at specified locations or at a specific type of locations, or to services which are available at specified locations or at a specific type of locations. Accordingly, products or services can be made available at several distribution points. As an example, in response to a supraregional request a bus or train permit can be issued at different boarding points.

The request for a product or service may be made based on a user's specific requirement or with reference to an assortment of generally available offerings. When a user has a specific requirement, for instance when he wants a train ticket, he will dial up the corresponding system and communicate with it regarding the transaction, thus applying the method within the scope of this invention by virtue of the user's initiative. Conversely, the provider may offer a range of available products or services, enabling the customers to familiarize themselves with, and select from, the offering. The process of matching demand and supply may include an adjustment that involves several communication steps. For example, when applying the method to travel, the user's desired points of departure and arrival would be reconciled with what the providing carrier has to offer.

Once the user has expressed his interest via the supraregional communications system, employing any potential mode of transmission, for instance in digital form employing a GPS/SMS system, GPRS, UMTS, the Internet, using for instance a so-called WAP connection or even voice mail, to be digitized and analyzed for instance in the provider's mainframe, the provider will use its database or similar inventory control system for an availability check. For example, in a parking garage employing local monitoring systems, a check would be made for an available parking space or a database simulation would determine and evaluate the current capacity. Where the product or service is available, the provider can satisfy the requirement. On the other hand, no availability check is needed in cases where no specific one-time requirement is involved, for instance when a general permit or time pass for local transportation etc. is to be purchased.

When a user commits to a product, the provider reserves that product by issuing a general authorization and a user code, also referred to as an ID, which is teletransmitted to the user's terminal and stored at the user's end. The code is verifiably assigned to the authorization.

The code may be generated in various ways. According to one proposed approach per this invention, the code can be generated manually as a character combination keyed in by the user. At the same time it may be desirable to also store the code in the user's mobile phone as a reminder or for reuse at a later date. ID codes can also be generated automatically or retrieved from a storage device and transmitted. It would be possible to use for instance the mobile-phone ID, the telephone number, telephone details such as serial number, or other device-identifying, electronically device-retrievable data such as details from the telephone calling card, the PIN or data from the telephone directory in the user's terminal.

At the provider's end the identification code assigned to the user is stored and fed into a device which is capable of communicating in proximity fashion, i.e. wireless and non-contact, with a user-held unit for retrieving the code stored therein, comparing it with the provider's assigned code or routing it to a comparator for verification.

At the user's end, the code identification system consists of a unit in which a code, personalized and exclusively assigned to the specific user, is stored. This unit can present the code for non-contact scanning, preferably by both the supraregional communications system at the user's end and by the code verification system at the provider's end. The code may be composed of digital characters which can be transmitted in non-contact fashion by way of various digital transmission carriers such as digital radio systems, optical links etc. In functional terms this code is a digital travel ticket, parking permit etc.

Code verification becomes possible as soon as a user enters the local area of the provider's verification unit. For the purpose of this invention, the term local area refers to an area extending over a short distance from the verification unit and enabling the verification unit to communicate with the code unit at the user's end.

Within the local area, communication takes place between the code verification system and the user via a local communications link. Such local communications links may be in the form of short-range radio systems, optical communications systems etc. Short-range radio or so-called Blue Tooth systems can be used for instance to complement mobile phone systems. Optical systems may be infrared links or the like. Depending on the application concerned, different local communications systems may be needed so as to also meet other requirements. Local communications systems can also be implemented by assembling and employing mobile radio telephone links.

When the provider's local communication system is capable of performing code verification, use and access authorization can be given. For example, parking-garage gates can be opened, product-release systems activated or controlled areas opened for access by the user. Stored authorizations can be reviewed, for instance for the automatic determination whether the person to whom the identification code was assigned is authorized to take a particular flight, to receive a particular product, etc.

In applying the method according to this invention, a reservation is associated with a specific identifying code. This code is communicated to the user only, authorizing only that particular user to exercise the option concerned by entering the code that is stored in his memory module before he exercises that option. This is referred to as a ticketing system.

Based on the personalized assignment of the user code, the system according to this invention can be expanded in simple fashion into an automated billing system. By way of the personalized association, the process can be linked with credit-card systems, centralized accounting systems such as the mobile phone service providers' accounting systems, a billing system based on stored billing information, or the provider's own user credit system.

The range of possible applications of the method according to this invention is extremely multifaceted and virtually inexhaustible. Examples include uses in parking-garage systems, at gas-station fuel pumps, at controlled-access facilities, in public commuter transportation as well as in long-distance carrier service including air travel, ferry service, at recreational facilities etc., but also in the realm of consumer products as for instance in the case of drive-in food pickup systems especially in the fast-food market, and other products as well. Conceivably, it should be possible to store at the distribution or shipping point of warehouses merchandise ordered via telecommunication links for release on presentation of an authorization code transmitted through the local communications link.

The system allows for a permanent user authorization, whereby the provider keeps the authorization associated with a given code on file, obviating the need for the user to obtain a new code for every transaction. This is particularly useful in connection with controlled-access authorizations or for the frequent use of recreational facilities such as swimming pools or saunas or for the regular use of the same public commuter conveyances.

As a special aspect of this invention in conjunction with rail travel, it is possible to collect on-board transaction data for collective transmission to specific points for instance within a railroad station. This makes it possible, for example, to register boarding and disembarkation data associated with particular permits or identification codes, for instance for the purpose of billing adjustments or perhaps only for statistical purposes.

Details of the method according to this invention and of the equipment-related features of the invention are provided in the following description of one applicational example and with the aid of the diagram where:

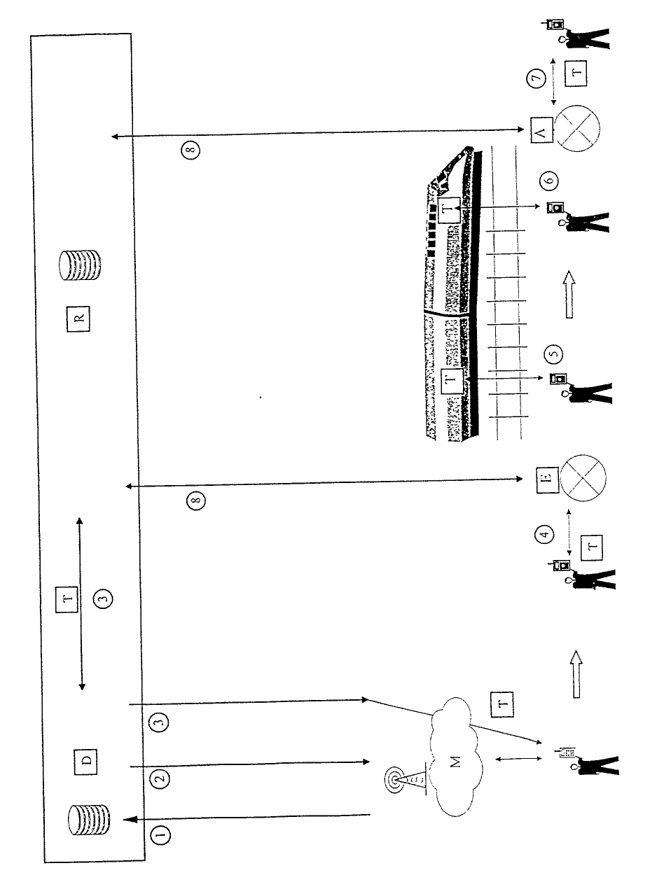

FIG. 1 is a schematic illustration of an implementation example of this invention.

The applicational example relates to the use of the method per this invention in the realm of local public transportation.

The starting scenario may vary considerably. The user may want to reserve his ticket either well in advance from a remote place, or immediately prior to boarding. Using a mobile phone, the user communicates with the provider, selects the points of departure and arrival and commits to a corresponding reservation 1, 2. In the simplest case this may be a ticket from A to B within a specific time frame, while in a complicated case it may involve multiple connecting lines and corresponding time intervals. Once the desired schedule is firmed up, the user sends a corresponding signal for the reservation whereupon the provider assembles the authorization package and issues a corresponding identification code T. Different codes may be assigned for different authorization segments. The provider stores the combination of utilization data and code and transmits at least the code T to the user as step 3, whereupon the issued code is stored in the user's communication terminal.

In addition, as part of the process, the user may be given directions. For example, if the user's exact location is known, the provider's computer can send him appropriate routing information. The user's location can be determined in different ways. For example, the user's system may be GPS-equipped, or the mobile-phone service provider who usually knows the precise point of origin of a cell-phone call to within a very short distance provides this geographic information. Given the user's location and his destination, a computer can now determine, and relay to the user, the best way to the destination point in due consideration of infrastructural circumstances, perhaps even of current traffic conditions, information on road-construction projects etc. The route display on the user's terminal may be in the form of arrow symbols, road maps, graphic illustrations or the like.

Once the user reaches the local area which in the case of public transportation is the point of departure, he proceeds to the local area of the provider's interactive authorization verification device E. It is also possible to place the verification device for instance aboard a train or bus per step 5 or 6, or in the gate area A of railroad stations per step 7. Using a communications interface designed for local operation, such as a Blue Tooth, an infrared port or the like, the user transmits the necessary identification code T to the provider's device E which, per step 4, automatically checks his authorization.

The ticketing method according to this invention provides for an identification code to be assigned to an authorization package, as explained in the example of a travel permit. The object may be a season ticket such as a monthly travel permit, or the application may be altogether different, for instance a regular admission ticket, an access permit etc.

The implementation example described above also encompasses the possibility of recording and transmitting attendance/usage/movement data per step 8 which are assembled and collectively transmitted in a corresponding tallying process for instance within a railroad station.

The application example described is intended for explanatory purposes only and is not limiting in nature. The equipment features specified relate to a system at the provider's end which is implemented either in separate subsystems or as an integrated system both for supraregional data telecommunications and for local operation. Also required at the provider's end is a computer capable of handling centralized activities, such as availability checks and perhaps accounting and billing, as well as distributed functions such as authorization verification and the like. The user needs to be equipped with a communications terminal for supraregional, remote data transfer, plus a unit for proximity-operated local communication to permit authorization verification.

Reference LIst

1, 2 User's selection of a provider's product or service

3 Transmission of an identification code I of an electronic ticket

4 Verification of access permit (optional)

5 Attendance/usage registration/on-board ticket check (optional)

6 Exit gate check (optional)

7 On-board disembarkation registration in train (optional)

8 Collection/transmission of attendance/usage/movement data (optional)

T Identification code/electronic ticket

M Mobile radio telephone network

E Entry/access control (optional)

A Exit/departure check (optional)

D List of products and services offered

R Reservation (optional)

1. Method for the automation of availability-checking, reservation and allocation processes for localized products and/or services, under utilization of a supraregional communications link and on the basis of a user's requirement, the method comprising:
a) the user selecting a provider's product or service;
b) the provider assigning to a requested item an authorization code which is transmitted to the user and is stored in a memory module of the user;
c) the provider reserving the item, storing the code, and forwarding a reservation and code information to a code verification system, under utilization of a local-area communications link;
d) triggering a non-contact, proximity code verification when the user enters within a range of the code verification system; and
e) granting an access to the user upon a positive code verification.

2. Method as in claim 1, characterized in that the supraregional communications link is a mobile radio telephone network system.

3. Method as in one of the preceding claims, characterized in that the local-area communications link is a mobile radio telephone network system.

4. Method as in one of the preceding claims, characterized in that the local-area communications link is a local-area radio network.

5. Method as in one of the preceding claims, characterized in that the authorization code for a particular use is issued for a limited area or time.

6. Method as in one of the preceding claims, characterized in that local-area communications link is enabled by the user.

7. Method as in one of the preceding claims, characterized in that the non-contact code verification is accomplished by optical means.

8. Method as in one of the preceding claims, characterized in that a code provided by the user for transmission and/or verification purposes is released by a selective activation.

9. Method as in one of the preceding claims, characterized in that the data-transfer, availability-checking, reservation and allocation or assignment processes are performed with the aid of a central mainframe processing system.

10. Method as in claim 9, characterized in that the central mainframe processing system is equipped with data telecommunications interfaces as well as systems for enquiry analysis, availability checking, generation and transmission of product or service offers, as well as a unit for issuing and transmitting an authorization code, for communicating with the code verification and/or access-authorization release systems and, where appropriate, with product or service delivery points.

11. Method as in one of the preceding claims, characterized in that the method is used for a ticketing system for public transportation.

12. Method as in one of the preceding claims, characterized in that, under utilization of a code and of an information related to its use, an accounting statement is automatically generated.
